(19) United States
(12) Patent Application Publication
(10) Pub. No.: US 2026/0307355 A1
(43) Pub. Date: Oct. 8, 2026

(54) APPARATUS AND METHOD FOR MANUFACTURING ELECTRODE PLATE

(71) Applicant: SK On Co., Ltd., Seoul (KR)

(72) Inventors: Hak Bong MUN, Daejeon (KR); Jae Sik SHIN, Daejeon (KR); Ki Sang YOO, Daejeon (KR); Kyeong Gab CHOI, Daejeon (KR); Jae Gyu BYUN, Daejeon (KR); Won Je OH, Daejeon (KR); Moon Hyung JUNG, Daejeon (KR)

(21) Appl. No.: 19/632,415

(22) Filed: Mar. 30, 2026

(30) Foreign Application Priority Data
Apr. 4, 2025 (KR) 10-2025-0044215
Nov. 10, 2025 (KR) 10-2025-0168374

(51) Int. Cl. B30B 3/00; B26F 1/12; B30B 3/04; H01M 4/04

(52) U.S. Cl. CPC B30B 3/005; B26F 1/12; B30B 3/04; H01M 4/0435

(57) ABSTRACT

An apparatus for manufacturing an electrode plate and a method for manufacturing an electrode plate are disclosed. In some implementations, an apparatus for manufacturing an electrode plate includes: a supply unit configured to supply an electrode plate; a pressing unit configured to press at least a portion of the electrode plate supplied from the supply unit; and a cutting unit configured to cut at least a portion of the electrode plate supplied from the pressing unit, wherein the pressing unit includes at least one pressing member configured to come into contact with the electrode plate, and the at least one pressing member has irregularities on a surface thereof.

### CROSS-REFERENCE TO RELATED APPLICATION(S)

This patent document claims the priority and benefits of Korean Patent Application No. 10-2025-0044215 filed on Apr. 4, 2025, and Korean Patent Application No. 10-2025-0168374 filed on Nov. 10, 2025, the disclosure of which are incorporated herein by reference in their entireties.

### TECHNICAL FIELD

The present disclosure relates to an apparatus and a method for manufacturing an electrode plate.

### BACKGROUND

Battery cells are widely used not only in small electronic devices such as mobile phones and laptop computers but also in medium and large mechanical devices such as electric vehicles (EVs), and are rechargeable and reusable.

Electrodes for a battery cell may include a positive electrode and a negative electrode, and the positive electrode and the negative electrode may include a positive electrode plate including a positive electrode active material and a negative electrode plate including a negative electrode active material, respectively. Such positive and negative electrode plates may be collectively referred to as electrode plates.

A separator may be interposed between the positive electrode plate and the negative electrode plate to electrically isolate the positive electrode plate and the negative electrode plate, thereby forming an electrode assembly. The electrode assembly may be manufactured in a stack type form, a stack-fold type form, or a wound type form.

A positive electrode lead may be connected to a region of the positive electrode plate where the positive electrode active material is not provided, and a negative electrode lead may be connected to a region of the negative electrode plate in which the negative electrode active material is not provided.

The electrode assembly may be accommodated, together with an electrolyte, in a case selected for its intended use, such as a pouch-type case, a prismatic case, or a cylindrical case, and the case may be sealed to manufacture a battery cell.

### SUMMARY

The present disclosure can be implemented in one aspect to provide an apparatus and a method for manufacturing an electrode plate capable of improving the efficiency of the electrode plate manufacturing process and the quality of the electrode plate.

The present disclosure can be widely applied to devices in green technology fields such as solar power generation and wind power generation.

In addition, the present disclosure can be applied to eco-friendly devices, such as electric vehicles and hybrid vehicles, which are intended to prevent climate change by suppressing air pollution and greenhouse gas emissions.

In some embodiments of the present disclosure, an apparatus for manufacturing an electrode plate includes: a supply unit configured to supply an electrode plate; a pressing unit configured to press at least a portion of the electrode plate supplied from the supply unit; and a cutting unit configured to cut at least a portion of the electrode plate supplied from the pressing unit, wherein the pressing unit includes at least one pressing member configured to come into contact with the electrode plate, and the at least one pressing member has irregularities on a surface thereof.

In some embodiments, the at least one pressing member may include a protruding region and a recessed region on the surface thereof.

In some embodiments, the apparatus for manufacturing an electrode plate may include a plurality of pressing members, the plurality of pressing members may include: a first pressing member configured to come into contact with one surface of the electrode plate; and a second pressing member configured to come into contact with the other surface of the electrode plate opposite to the one surface of the electrode plate, and at least one of the first pressing member and the second pressing member may include irregularities on a surface thereof.

In some embodiments, each of the first pressing member and the second pressing member may include a roller having irregularities formed on a surface thereof, and configured to come into contact with the electrode plate.

In some embodiments, the first pressing member may include a first roller having irregularities on a surface thereof, and the second pressing member may include a second roller having a flat region on a surface thereof.

In some embodiments, at least one of the first pressing member and the second pressing member may include a tapered region, with the irregularities provided in the tapered region.

In some embodiments, each of the first pressing member and the second pressing member may include a roller, with the irregularities provided in a circumferential direction of the roller.

In some embodiments, the irregularities may be provided in a predetermined pattern on the surface of the at least one pressing member.

In some embodiments, the first pressing member may include a first roller having irregularities on a surface thereof, and the second pressing member may include a second roller having irregularities on a surface thereof.

In some embodiments, each of the first roller and the second roller may include a tapered region.

In some embodiments, the at least one pressing member may include a roller, and the protruding region and the recessed region may be alternately arranged in a circumferential direction of the roller.

In some embodiments, the apparatus may further include: at least one actuator configured to rotate the at least one pressing member in a state in which the surface of the at least one pressing member on which the irregularities are formed is in contact with the electrode plate.

In some embodiments, the surface of the at least one pressing member may include: an irregular region in which the irregularities are formed; and a flat region disposed adjacent to the irregular region.

In another aspect of the present disclosure, a method for manufacturing an electrode plate includes: a pressing step of receiving, from a supply unit configured to supply an electrode plate, the electrode plate and pressing at least a portion of the electrode plate; a deforming step of deforming at least a portion of the electrode plate during the pressing step; and a cutting step of cutting at least a portion of the electrode plate after the deforming step is completed.

In some embodiments, in the deforming step, at least a portion of the electrode plate may be stretched or bent in a predetermined pattern.

In some embodiments, in the cutting step, at least a portion of the electrode plate may be notched.

According to one aspect of the present disclosure, it is possible to provide an apparatus and a method for manufacturing an electrode plate capable of improving the efficiency of the electrode plate manufacturing process and the quality of the electrode plate.

The present disclosure can be widely applied in green technology fields such as solar power generation and wind power generation.

In addition, the present disclosure can be applied to eco-friendly devices, such as electric vehicles and hybrid vehicles, which are intended to prevent climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic view of an apparatus for manufacturing an electrode plate according to some embodiments of the present disclosure.

FIG. 2 is a schematic perspective view of a pressing unit according to some embodiments of the present disclosure.

FIG. 3 is an enlarged perspective view of a portion of a pressing member according to some embodiments of the present disclosure.

FIG. 4 schematically illustrates a cross section in a thickness direction of an electrode plate.

FIG. 5 is a schematic perspective view of a pressing unit according to other embodiments of the present disclosure.

FIG. 6 is a schematic perspective view of a pressing unit according to other embodiments of the present disclosure.

FIG. 7 is a schematic front view of a portion of a pressing member according to other embodiments of the present disclosure.

FIG. 8 is a schematic front view of a portion of a pressing member according to other embodiments of the present disclosure.

FIG. 9 schematically illustrates a method for manufacturing an electrode plate according to some embodiments of the present disclosure.

### DETAILED DESCRIPTION

To facilitate understanding of the description of the embodiments of the present disclosure, elements denoted by the same reference numerals in the accompanying drawings are the same elements. Some components in the accompanying drawings may be exaggerated, omitted, or schematically illustrated, and the sizes of the respective components do not fully reflect their actual sizes.

In addition, in order to clarify the gist of the present disclosure, descriptions of elements and techniques well known by the prior art are omitted. Hereinafter, the present disclosure will be described in detail with reference to the accompanying drawings. However, the following description is provided for illustrative purposes only, and the present disclosure is not limited to specific embodiments exemplarily described.

The “embodiments” mentioned below do not necessarily refer to the same embodiments. Specific features, structures, or characteristics may be combined or substituted in any suitable manner consistent with the present disclosure.

Hereinafter, in the drawings, an X-axis represents a longitudinal direction of an electrode plate 10, a Y-axis represents a thickness direction of the electrode plate 10, and a Z-axis represents a width direction of the electrode plate 10. However, these directions are arbitrarily set for convenience of understanding, and the above-described directions may be changed.

In the accompanying drawings, a point at which the X-axis, the Y-axis, and the Z-axis intersect may be an origin or a zero point. Any region in the accompanying drawings may be set as an origin or a zero point. When an arbitrary region or point in the accompanying drawings is set as an origin or a zero point, the X-axis, Y-axis, and Z-axis illustrated in the drawings may maintain the same state as illustrated in the drawings with respect to the set origin or zero point. In addition, the X-axis, Y-axis, and Z-axis illustrated in the accompanying drawings are illustrated in the positive (+) directions, and the negative (−) directions may be understood as directions opposite to the positive (+) directions with reference to the origin or zero point.

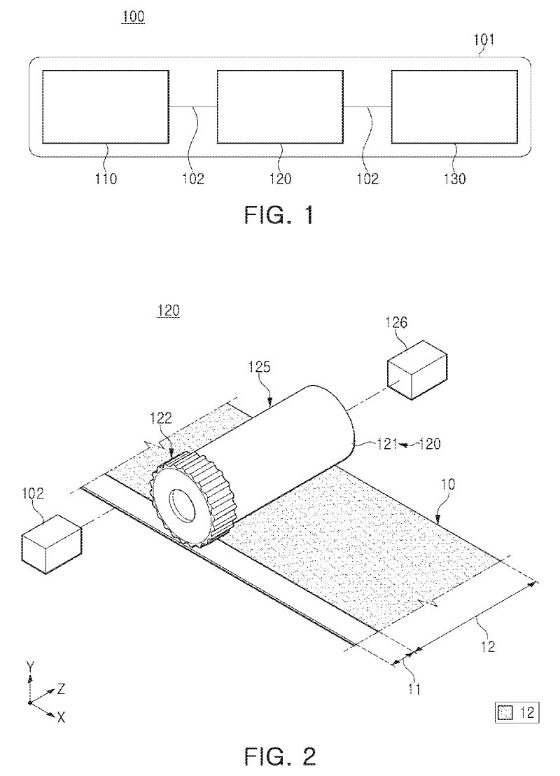

FIG. 1 is a schematic view of an apparatus for manufacturing an electrode plate 10 according to some embodiments of the present disclosure, and FIG. 2 is a schematic perspective view of a pressing unit 120 according to some embodiments of the present disclosure, illustrating a state in which the pressing unit 120 presses the electrode plate 10.

As shown in FIGS. 1 and 2, the apparatus for manufacturing the electrode plate 10 according to some embodiments of the present disclosure may include a supply unit 110 that supplies the electrode plate 10, a pressing unit 120 that presses at least a portion of the electrode plate 10 supplied from the supply unit 110, and a cutting unit 130 that cuts at least a portion of the electrode plate 10 supplied from the pressing unit 120. Here, the pressing unit 120 may include at least one pressing member 121 that comes into contact with the electrode plate 10. The at least one pressing member 121 may have irregularities 122 on a surface thereof.

In some embodiments, the supply unit 110 may include a winding device, an unwinding device, a reel, or the like for supplying the electrode plate 10, and may further include a guide device or the like for aligning the position of the electrode plate 10.

In some embodiments, the supply unit 110 may continuously supply the electrode plate 10. In some embodiments, the electrode plate 10 may include copper, aluminum, nickel, stainless steel, titanium, or the like. The material of the electrode plate 10 may be determined based on the electrical polarity of the electrode plate 10. The electrode plate 10 may be a positive electrode plate or a negative electrode plate.

In some embodiments, the supply unit 110 may supply the electrode plate 10 to a device base 101 or the like. The electrode plate 10 may be transferred to a subsequent process along the device base 101 by at least one transfer unit 102.

For example, the transfer unit 102 may include a robot arm, a pickup member, a vacuum suction device, a conveyor device, or the like, but the type of the transfer unit is not limited by the present disclosure as long as the transfer unit facilitates the transfer of the electrode plate 10.

In some embodiments, the pressing unit 120 may receive the electrode plate 10 supplied from the supply unit 110 and press at least a portion of the electrode plate 10.

In some embodiments, the cutting unit 130 may receive the electrode plate 10 that has been pressed by the pressing unit 120 and cut at least a portion of the electrode plate 10.

In some embodiments, the pressing unit 120 may press the electrode plate 10 before the electrode plate 10 is cut by the cutting unit 130. Accordingly, the electrode plate 10 may be pressed prior to a process of cutting the electrode plate 10. This may contribute to improving the cutting quality of the electrode plate 10.

In some embodiments, the cutting unit 130 may notch at least a portion of the electrode plate 10. The cutting unit 130 may include a laser device, a cutting blade, or the like, but the type, form, and operation method of the cutting unit 130 are not limited by the present disclosure.

As described above, the electrode plate 10 may be transferred from the pressing unit 120 to the cutting unit 130 by the transfer unit. However, the transfer unit may be omitted as necessary.

In some embodiments, the at least one pressing member 121 may include a roller. The roller may be disposed such that a surface thereof comes into contact with the electrode plate 10, and may be configured to rotate.

In some embodiments, the apparatus for manufacturing the electrode plate 10 may further include at least one actuator 126 that rotates the at least one pressing member 121 in a state where a surface of the at least one pressing member 121 on which the irregularities 122 are formed is in contact with the electrode plate 10.

The at least one actuator 126 may include a motor, a robot arm, a reducer, a coupling, or the like. A rotation shaft of the motor may be connected to a shaft of the roller through the reducer or the like. However, the type and form of the actuator 126 are not limited by the present disclosure. The actuator 126 may be electrically and/or physically connected to a control unit, and the control unit may control a rotation direction of the at least one pressing member 121, a rotation speed of the at least one pressing member 121, whether to rotate the at least one pressing member 121, etc. by controlling the actuator 126. For example, the control unit may include a microprocessor or the like.

Irregularities 122 may be provided on at least a portion of a surface of the roller. The irregularities 122 may come into contact with a non-coated region 11 of the electrode plate 10, and the roller may press the non-coated region 11 of the electrode plate 10 with its surface on which the irregularities 122 are formed.

While the roller rotates, the electrode plate 10 may also be transferred at a predetermined speed. The roller may press the electrode plate 10 with an appropriate load, and for this purpose, the roller may further include additional components such as a cylinder and a robot arm. The roller may be configured to adjust the magnitude of the force for pressing the electrode plate 10.

In some embodiments, an electrode active material may be coated on at least a portion of the electrode plate 10. The electrode active material may be determined depending on the electrical polarity of the electrode plate 10.

For example, when the electrode plate 10 is a positive electrode plate, the electrode plate 10 may be made of a material including aluminum, and the electrode active material may include a positive electrode active material.

When the electrode plate 10 is a negative electrode plate, the electrode plate 10 may be made of a material including copper, and the electrode active material may include a negative electrode active material.

A region of the electrode plate 10 where the electrode active material is coated may be an active material region 12, and a region of the electrode plate 10 where the electrode active material is not coated may be a non-coated region 11. The active material region 12 and the non-coated region 11 may be disposed adjacent to each other in the electrode plate 10. An area of the non-coated region 11 may be relatively smaller than an area of the active material region 12.

In some embodiments, the non-coated region 11 may be notched by the cutting unit 130.

The non-coated region 11 may be pressed by the region where the irregularities 122 are formed, and the active material region 12 may face a flat region 125, which is a region having a flat surface, of the pressing member 121. However, the active material region 12 may not be in contact with the flat region 125. Accordingly, the active material region 12 may not be pressed. As a result, the active material region 12 may be prevented from being damaged and deformed.

In some embodiments, the surface of the at least one pressing member 121 may include an irregular region where the irregularities 122 are formed, and a flat region 125 disposed adjacent to the irregular region.

A width in the Z direction of the region of the pressing member 121 in which the irregularities 122 are formed may correspond to a width in the Z direction of the non-coated region 11, and a width in the Z direction of the flat region 125 of the pressing member 121 may correspond to a width in the Z direction of the active material region 12.

The pressing member 121 may press the non-coated region 11. Accordingly, the surface waviness of the electrode plate 10 may be flattened. For example, the pressing member 121 may press the non-coated region 11 with its surface having irregularities 122.

Alternatively, in some embodiments, the pressing member 121 may press the non-coated region 11 with its surface having a flat region 125.

Meanwhile, the electrode plate 10, which serves as a current collector, may exhibit waviness during a rolling process. Therefore, by pressing the electrode plate 10, particularly the non-coated region 11, with the pressing member 121, the electrode plate 10 can be stretched. Accordingly, when the electrode active material is coated on the electrode plate 10, interfacial contact can be uniform, thereby minimizing or preventing the thickness variation of the electrode plate 10. This may contribute to improving the quality of the electrode plate 10.

In addition, the poor contact of the electrode plate 10 caused by waviness can be suppressed, thereby reducing electrical resistance.

Furthermore, the tensile strength of the electrode plate 10 can also be increased, thereby preventing the deformation or breakage of the electrode plate 10 in a process of assembling the electrode plate 10 into an electrode assembly.

In addition, the waviness of the electrode plate 10 can be minimized or eliminated before the electrode plate 10 is cut, thereby improving the cutting quality of the electrode plate 10.

In some embodiments, the pressing member 121 may be disposed upstream of the cutting unit 130 in the device base 101 to press the electrode plate 10 before the electrode plate 10 is cut. The electrode plate 10 may be pressed by the pressing member 121 before being supplied to the cutting unit 130.

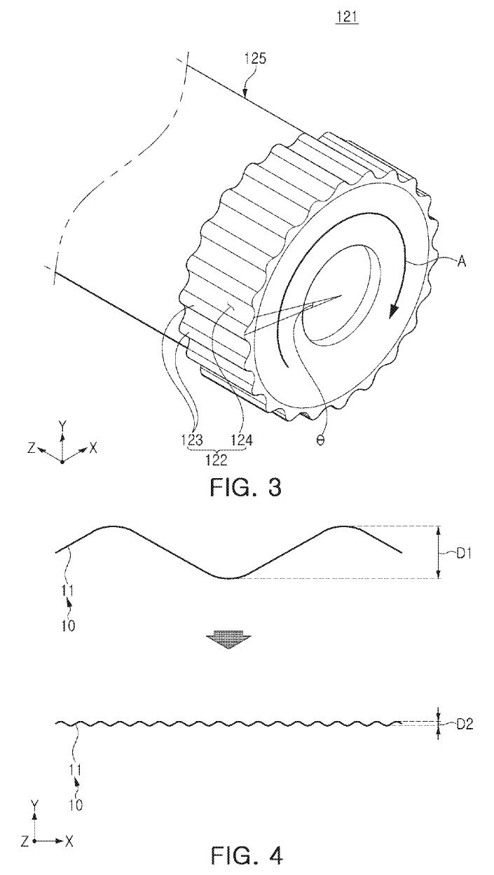

FIG. 3 is an enlarged perspective view of a portion of the pressing member 121 according to some embodiments of the present disclosure. As shown in FIGS. 2 and 3, the at least one pressing member 121 may include a roller, and the roller may have irregularities 122 along a circumferential direction A of the roller. The roller may have irregularities 122 on a surface thereof that comes into contact with the non-coated region 11.

In some embodiments, the at least one pressing member 121 or the roller may include a protruding region 123 and a recessed region 124 in at least a portion of a surface thereof.

In some embodiments, a protruding height of the protruding region 123 or a recessed depth of the recessed region 124 may be 0.2 mm or more and 0.5 mm or less.

For example, the protruding height of the protruding region 123 or the recessed depth of the recessed region 124 may be 0.395 mm.

In some embodiments, in a cross section in the thickness direction (X–Y plane) of the pressing member 121, an angle θ formed by a line extending from the center of the protruding region 123 to the center of the pressing member 121 and a line extending from the center of the recessed region 124 to the center of the pressing member 121 may be 3° or more and 5° or less. For example, the angle θ may be 4°.

In some embodiments, the at least one pressing member 121 or the roller may be configured such that the protruding region 123 and the recessed region 124 are alternately arranged along the circumferential direction A of the pressing member 121 or the roller.

For example, the recessed region 124 may be disposed between a pair of protruding regions 123. The protruding region 123, which is a region where the surface of the roller relatively protrudes, may be formed such that the surface of the roller protrudes in a direction away from the center of the roller.

Alternatively, a relatively protruding region may be formed on the surface of the roller by intermittently forming the recessed regions 124 on the surface of the roller.

The shapes of the protruding region 123 and the recessed region 124, the protruding height and the recessed depth of the protruding region 123 and the recessed region 124, and the like are not limited by the present disclosure.

In some embodiments, the roller may have a predetermined rigidity. The surface of the roller may be formed of any suitable material as long as it does not cause undue damage to the surface of the electrode plate 10.

In some embodiments, the surface of the roller may include urethane, but the material of the roller, the material of the roller surface, and the like are not limited by the present disclosure.

FIG. 4 schematically illustrates a cross section in the thickness direction (X–Y plane) of the electrode plate 10, in which the electrode plate 10 is illustrated in an enlarged manner.

As shown in FIGS. 3 and 4, the irregularities 122 may be formed on a surface of the roller or the at least one pressing member 121 that comes into contact with the non-coated region 11. The irregularities 122 may press the non-coated region 11 to stretch the surface of the non-coated region 11, thereby suppressing the waviness of the electrode plate 10.

For example, before being pressed by the pressing member 121 or the roller, the electrode plate 10 may have a depth or amplitude of waviness of a first depth D1.

The electrode plate 10 that has been pressed by the pressing member 121 or the roller may have a reduced depth of waviness. In addition, the electrode plate 10 that has been pressed by the pressing member 121 or the roller may be stretched, and the region that previously had the first depth D1 may have a second depth D2. The second depth D2 may have a smaller value than the first depth D1.

After the electrode plate 10 has been pressed, at least one of an amplitude or a period of the waviness of the electrode plate 10 may be changed.

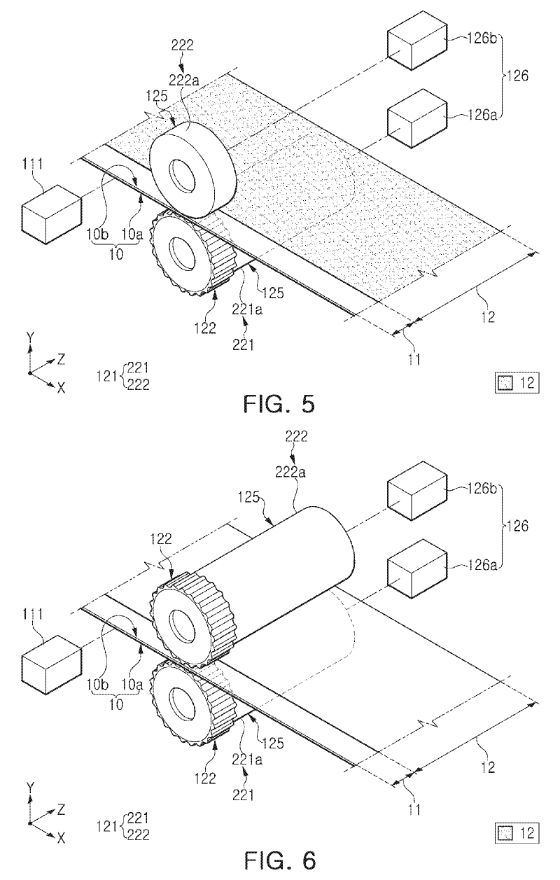

FIG. 5 is a schematic perspective view of a pressing unit 120 according to other embodiments of the present disclosure, illustrating a state in which the pressing unit 120 presses the electrode plate 10. As shown in FIG. 5, in some embodiments of the present disclosure, the at least one pressing member 121 may include a plurality of pressing members 121. The plurality of pressing members 121 may include a first pressing member 221 that comes into contact with one surface of the electrode plate 10 and a second pressing member 222 that comes into contact with the other surface of the electrode plate 10 opposite to one surface of the electrode plate 10. In addition, at least one of the first pressing member 221 and the second pressing member 222 may have irregularities 122 on a surface thereof.

In some embodiments, each of the first pressing member 221 and the second pressing member 222 may include a roller. Each roller may press the non-coated region 11.

The actuator 126 may include a plurality of actuators 126, and the plurality of actuators 126 may include a first actuator 126a that rotates the first pressing member 221 and a second actuator 126b that rotates the second pressing member 222.

In some embodiments, the first pressing member 221 may press one surface 10a of the electrode plate 10, and the second pressing member 222 may press the other surface 10b of the electrode plate 10. For example, the first pressing member 221 may press the non-coated region 11 on one surface 10a of the electrode plate 10, and the second pressing member 222 may press the non-coated region 11 on the other surface 10b of the electrode plate 10.

In some embodiments, the first pressing member 221 may include a first roller 221ahaving irregularities 122 and a flat region 125, and the second pressing member 222 may include a second roller 222ahaving a flat region 125, which is a region having a flat surface. The second pressing member 222 may not have irregularities 122, and the other surface 10b of the electrode plate 10 may be pressed only by the flat region 125. On the other surface 10b of the electrode plate 10, both the non-coated region 11 and the active material region 12 of the electrode plate 10 may be pressed by the flat region 125. The other surface 10b of the electrode plate 10 may also be stretched to a certain extent.

On a surface 10a of the electrode plate 10, the non-coated region 11 may be pressed by the irregularities 122. On a surface 10a of the electrode plate 10, the electrode plate 10 may be stretched relatively more in the non-coated region 11 than in the active material region 12.

The shape, pattern, and depth of the irregularities 122 may be appropriately selected and applied in consideration of an amount by which the electrode plate 10 is to be stretched.

FIG. 6 is a schematic perspective view of a pressing unit 120 according to other embodiments of the present disclosure, illustrating a state in which the pressing unit 120 presses the electrode plate 10. As shown in FIG. 6, in some embodiments of the present disclosure, each of the first pressing member 221 and the second pressing member 222 may have irregularities 122 formed on a surface thereof, and each of the first pressing member 221 and the second pressing member 222 may include a roller that comes into contact with the electrode plate 10.

In some embodiments, the first pressing member 221 may press the non-coated region 11 with the irregularities 122 on a surface 10a of the electrode plate 10.

In some embodiments, the second pressing member 222 may press the non-coated region 11 with the irregularities 122 on the other surface 10b of the electrode plate 10.

The irregularities 122 of the first pressing member 221 and the irregularities 122 of the second pressing member 222 may overlap in the thickness direction (Y direction) of the electrode plate 10, and the flat region 125 of the first pressing member 221 and the flat region 125 of the second pressing member 222 may also overlap in the thickness direction (Y direction) of the electrode plate 10.

In some embodiments, the active material region 12 may face the flat region 125, and the active material region 12 may not be pressed. The non-coated region 11 may be pressed by the irregularities 122. A stretching amount and a waviness amplitude of the active material region 12 may be different from a stretching amount and a waviness amplitude of the non-coated region 11.

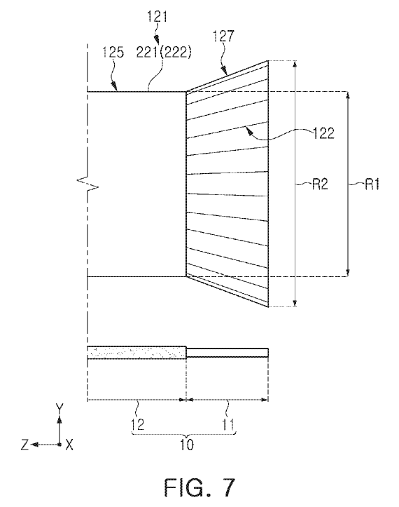

FIG. 7 is a schematic front view of a portion of a pressing member 121 according to other embodiments of the present disclosure. The pressing member 121 illustrated in FIG. 7 may be either the first pressing member 221 or the second pressing member 222.

As shown in FIG. 7, in some embodiments of the present disclosure, at least one of the first pressing member 221 and the second pressing member 222 may include a tapered region 127. Here, irregularities 122 may be formed in the tapered region 127. The tapered region 127 may be an inclined region.

In some embodiments, the first pressing member 221 may include a first roller 221a, and the second pressing member 222 may include a second roller 222a. In this case, at least one of the first roller 221a and the second roller 222a may include a tapered region.

For example, either the first roller 221a or the second roller 222a may include a tapered region 127, or both the first roller 221a and the second roller 222a may include tapered regions 127.

In some embodiments, the first pressing member 221 may include a tapered region 127 including irregularities 122 and a flat region 125 disposed adjacent to the tapered region 127.

The non-coated region 11 of the electrode plate 10 may be pressed by the tapered region 127, and the active material region 12 of the electrode plate 10 may face the flat region 125. The active material region 12 may not be pressed.

In some embodiments, a width (a width in the Y direction) or a diameter of the flat region 125 of the first pressing member 221 may be a first diameter R1, and a maximum width or a maximum diameter of the tapered region 127 may be a second diameter R2. In addition, a minimum width of the tapered region 127 may be the first diameter R1. The second diameter R2 may have a larger value than the first diameter R1. Accordingly, the tapered region 127 may be formed in the first pressing member 221. The tapered region 127 of the second pressing member 222 may also be formed in the same manner. In this case, the non-coated region 11 may be pressed relatively more in a region relatively farther from the active material region 12 than in a region closer to the active material region 12. Accordingly, the non-coated region 11 may be stretched more in a region farther from the active material region 12. In this manner, the present disclosure makes it possible to stretch the non-coated region 11 by different amounts even through a single pressing operation.

In some embodiments, each of the first pressing member 221 and the second pressing member 222 may include a roller. For example, the first pressing member 221 may include a first roller 221ahaving irregularities 122 on a surface thereof, and the second pressing member 222 may include a second roller 222ahaving irregularities 122 on a surface thereof.

In some embodiments, the irregularities 122 may be provided in the circumferential direction of the first roller 221a and in the circumferential direction of the second roller 222a.

In some embodiments, the non-coated region 11 may be pressed by the tapered region 127 of the first pressing member 221 and the tapered region 127 of the second pressing member 222. For example, a surface of the non-coated region 11 may be pressed by the tapered region 127 of the first pressing member 221, and the tapered region 127 of the second pressing member 222 may press the other surface of the non-coated region 11.

The non-coated region 11 may be interposed between the first pressing member 221 and the second pressing member 222, and the non-coated region 11 may be interposed between the tapered region 127 of the first pressing member 221 and the tapered region 127 of the second pressing member 222. The non-coated region 11 may be pressed by the tapered region 127 of the first pressing member 221 and the tapered region 127 of the second pressing member 222.

In some cases, only the first pressing member 221 may include a tapered region 127, and the second pressing member 222 may not be tapered. For example, a surface of the non-coated region 11 may be pressed by the tapered region 127 of the first pressing member 221, and the other surface of the non-coated region 11 may be pressed by a flat region of the second pressing member 222 that is not tapered. This is not necessarily limited by the present disclosure, and may be appropriately selected and applied according to specifications required for the electrode plate 10 or the like.

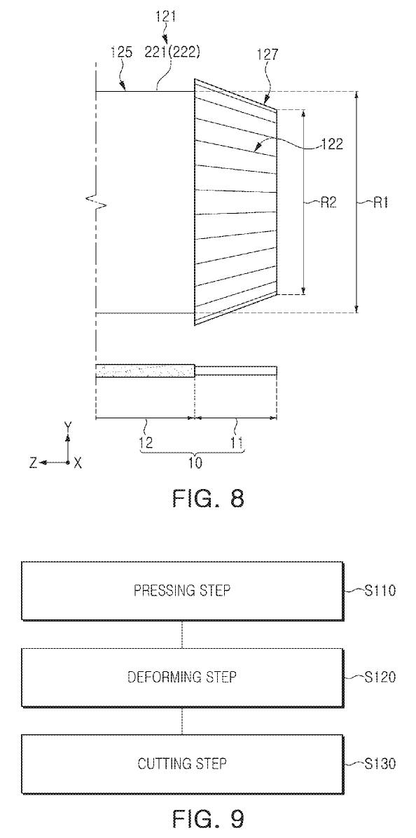

FIG. 8 is a schematic front view of a portion of a pressing member 121 according to other embodiments of the present disclosure. The pressing member 121 illustrated in FIG. 8 may be either the first pressing member 221 or the second pressing member 222.

As shown in FIG. 8, in some embodiments of the present disclosure, a width (a width in the Y direction) or a diameter of the flat region 125 of the first pressing member 221 may be a first diameter R1, and a minimum width or a minimum diameter of the tapered region 127 may be a second diameter R2. In addition, a maximum width (a width in the Y direction) of the tapered region 127 may be the first diameter R1.

The second diameter R2 may have a smaller value than the first diameter R1. Accordingly, the tapered region 127 may be formed in the first pressing member 221. The tapered region 127 of the second pressing member 222 may also be formed in the same manner. In this case, an end portion in the −Z direction of the non-coated region 11 may be stretched in a concentrated manner. For example, the non-coated region 11 may be pressed relatively more in a region closer to the active material region 12 than in a region farther from the active material region 12. As a result, the non-coated region 11 can be stretched by different amounts.

In some embodiments, irregularities 122 may be provided in a predetermined pattern on a surface of the at least one pressing member 121.

For example, the irregularities 122 may have a specific shape repeated in the circumferential direction of the pressing member 121. The irregularities 122 may have a polygonal shape, a circular shape, or the like.

In some embodiments, the first pressing member 221 may have a first diameter R1 corresponding to the minimum width of the tapered region 127, and the second pressing member 222 may have a first diameter R1 corresponding to the maximum width of the tapered region 127, or vice versa. That is, the first pressing member 221 may have a first diameter R1 corresponding to the maximum width of the tapered region 127, and the second pressing member 222 may have a first diameter R1 corresponding to the minimum width of the tapered region 127. Accordingly, when the non-coated region 11 is interposed between the first pressing member 221 and the second pressing member 222, the non-coated region 11 may be pressed by the first pressing member 221 and the second pressing member 222, which are inclined in a misaligned manner.

In addition, for example, both the first pressing member 221 and the second pressing member 222 may have tapered regions 127 whose minimum widths correspond to the first diameter R1 or maximum widths correspond to the first diameter R1.

The minimum widths or maximum widths of the tapered regions 127 of the first pressing member 221 and the second pressing member 222 are not necessarily limited by the present disclosure, and may be appropriately selected and applied in consideration of the stretching characteristics, waviness characteristics, etc. of the electrode plate.

In another aspect, the present disclosure provides a method for manufacturing the electrode plate 10. FIG. 9 schematically illustrates a method for manufacturing the electrode plate 10 according to some embodiments of the present disclosure. As shown in FIGS. 1 to 9, the method for manufacturing the electrode plate 10 according to some embodiments of the present disclosure may include: a pressing step S110 of receiving the electrode plate 10 from the supply unit 110 that supplies the electrode plate 10 and pressing at least a portion of the electrode plate 10; a deforming step S120 of deforming at least a portion of the electrode plate 10 during the pressing step S110; and a cutting step S130 of cutting at least a portion of the electrode plate 10 after the deforming step S120 is completed.

In some embodiments, the pressing step S110 may be performed by at least one pressing member 121. In the pressing step S110, the electrode plate 10 may be pressed by at least one of the irregularities 122 and the flat region 125.

In the deforming step S120, at least a portion of the electrode plate 10 may be deformed. For example, at least a portion of the electrode plate 10 may be stretched or bent. Also, for example, in the deforming step S120, at least a portion of the electrode plate 10 may be bent while being stretched.

At least a portion of the electrode plate 10 may include a non-coated region 11.

In some embodiments, in the deforming step S120, at least a portion of the electrode plate 10 may be stretched or bent in a predetermined pattern.

In some embodiments, the cutting step S130 may be performed after the deforming step S120 is completed. Also, for example, in the cutting step S130, at least a portion of the electrode plate 10 may be notched. For example, in the cutting step S130, the non-coated region 11 of the electrode plate 10 may be notched.

In some embodiments, the cutting step S130 may be performed after the deforming step S120 is completed. In the cutting step S130, the portion of the electrode plate 10 deformed in the deforming step S120 may be cut.

The present disclosure makes it possible to prevent fracture and damage of the electrode plate 10 or the non-coated region 11, and improve the quality of the electrode plate 10.

In addition, the present disclosure makes it possible to suppress the waviness of the electrode plate 10 and stretch the electrode plate 10 before the non-coated region 11 of the electrode plate 10 is notched. The present disclosure makes it possible to improve the electrical performance of the electrode plate 10 and improve the cutting quality of the electrode plate 10.

The above description merely provides examples to which the principles of the present disclosure have been applied, and other configurations may be added or certain configurations may be replaced with other configurations without departing from the scope of the present disclosure. In addition, the above-described embodiments may be substituted for each other or combined with each other.

What is claimed is:

1. An apparatus for manufacturing an electrode plate, the apparatus comprising:
a supply unit configured to supply an electrode plate;
a pressing unit configured to press at least a portion of the electrode plate supplied from the supply unit; and
a cutting unit configured to cut at least a portion of the electrode plate supplied from the pressing unit,
wherein the pressing unit includes at least one pressing member configured to come into contact with the electrode plate, and
the at least one pressing member has irregularities on a surface thereof.

2. The apparatus of claim 1, wherein
the at least one pressing member includes a protruding region and a recessed region on the surface thereof.

3. The apparatus of claim 1, wherein
the apparatus includes a plurality of pressing members,
the plurality of pressing members include:
a first pressing member configured to come into contact with a surface of the electrode plate; and
a second pressing member configured to come into contact with the other surface of the electrode plate opposite to the a surface of the electrode plate, and
at least one of the first pressing member and the second pressing member includes irregularities on a surface thereof.

4. The apparatus of claim 3, wherein
each of the first pressing member and the second pressing member includes a roller having irregularities formed on a surface thereof, and configured to come into contact with the electrode plate.

5. The apparatus of claim 3, wherein
the first pressing member includes a first roller having irregularities on a surface thereof, and
the second pressing member includes a second roller having a flat region on a surface thereof.

6. The apparatus of claim 3, wherein
at least one of the first pressing member and the second pressing member includes a tapered region, with the irregularities provided in the tapered region.

7. The apparatus of claim 6, wherein
each of the first pressing member and the second pressing member includes a roller, with the irregularities provided in a circumferential direction of the roller.

8. The apparatus of claim 1, wherein
the irregularities are provided in a predetermined pattern on the surface of the at least one pressing member.

9. The apparatus of claim 3, wherein
the first pressing member includes a first roller having irregularities on a surface thereof, and
the second pressing member includes a second roller having irregularities on a surface thereof.

10. The apparatus of claim 9, wherein
each of the first roller and the second roller includes a tapered region.

11. The apparatus of claim 2, wherein
the at least one pressing member includes a roller, and
the protruding region and the recessed region are alternately arranged in a circumferential direction of the roller.

12. The apparatus of claim 1, further comprising:
at least one actuator configured to rotate the at least one pressing member in a state in which the surface of the at least one pressing member on which the irregularities are formed is in contact with the electrode plate.

13. The apparatus of claim 1, wherein
the surface of the at least one pressing member includes:
an irregular region in which the irregularities are formed; and
a flat region disposed adjacent to the irregular region.

14. A method for manufacturing an electrode plate, the method comprising:
a pressing step of receiving, from a supply unit configured to supply an electrode plate, the electrode plate and pressing at least a portion of the electrode plate;
a deforming step of deforming at least a portion of the electrode plate during the pressing step; and
a cutting step of cutting at least a portion of the electrode plate after the deforming step is completed.

15. The method of claim 14, wherein
in the deforming step, at least a portion of the electrode plate is stretched or bent in a predetermined pattern.

16. The method of claim 14, wherein
in the cutting step, at least a portion of the electrode plate is notched.
